(19) United States
(12) Patent Application Publication
(10) Pub. No.: US 2010/0225765 A1
(43) Pub. Date: Sep. 9, 2010

(54) MONITORING SUPPORT APPARATUS, MONITORING SUPPORT METHOD, AND RECORDING MEDIUM

(75) Inventor: Shogo KADOGAWA, Fukuoka (JP)

Correspondence Address: STAAS & HALSEY LLP, SUITE 700, 1201 NEW YORK AVENUE, N.W., WASHINGTON, DC, 20005, US

(73) Assignee: FIJITSU LIMITED, Kawasaki (JP)

(21) Appl. No.: 12/713,697

(22) Filed: Feb. 26, 2010

(30) Foreign Application Priority Data
Mar. 3, 2009 (JP) 2009-049229

(51) Int. Cl. H04N 7/18

(52) U.S. Cl. 348/159; 348/E07.085

(57) ABSTRACT

A monitoring support apparatus includes an image shot information acquiring unit which acquires image shot information including a plurality of frames shot up by a plurality of cameras at different image shooting times, a difference region extracting unit which, in the pieces of image shot information acquired by the image shot information acquiring unit, compares an arbitrary frame with a frame shot at image shooting time different from that of the arbitrary frame or a background frame shot in advance to detect a region including different pixel values and extracts the detected pixel region as a difference region for each of the pieces of image shot information, and a superimposing unit which superimposes the difference regions of the pieces of image shot information extracted by the difference region extracting unit at the same time to generate one frame.

### CROSS-REFERENCE TO RELATED APPLICATIONS

This Nonprovisional application claims priority under 35 U.S.C. §119(a) on Patent Application No. 2009-049229 filed in Japan on Mar. 3, 2009, the entire contents of which are hereby incorporated by reference.

### FIELD

The present invention relates to a monitoring support apparatus which supports a monitoring system using a security camera.

### BACKGROUND

Monitoring for a building, a facility, or the like is performed by displaying a video image shot by a camera on a monitor. When the number of cameras is larger than the number of monitors, a camera the image of which is displayed on a monitor is switched, or a screen is vertically and horizontally divided into 4 screens, 9 screens, 16 screens, or the like to display video images of a plurality of cameras.

However, when cameras are switched, a video image except for a video image of the camera being displayed on the monitor cannot be watched on real time, and the monitoring cannot be performed without missing. When a monitor is vertically and horizontally divided to display the images in order to display a large number of camera video images, a video image display region for each camera becomes small. As a result, the images cannot be clearly watched. Furthermore, since lines of sight must be moved for every divided region, an observer is heavily loaded and easily overlooks the images. In addition, since a video image of a camera is always displayed even when a video image of a camera does not change (when the image need not be monitored because an intruder or an operator is not present), an observer must be carefully watch the monitor regardless of the presence/absence of a change of video image, and the observer is heavily loaded.

As techniques related to the above problem, a technique which compares a background image and an input image and detects a state of an object to be monitored from a differential image and a technique in which a plurality of frames are overlapped on the same screen to display the image are disclosed (for example, see Japanese Laid-open Patent Publication Nos. 2008-54243 and H9-98343).

However, the technique described in Japanese Laid-open Patent Publication No. 2008-54243 has the following problem. That is, when an abnormal traffic state is detected, an image of a corresponding camera is displayed on a screen. For this reason, when the abnormal state is detected by a plurality of cameras, images are displayed on a multi-screen, and a load on an observer increases.

When the multi-screen is displayed, a video image display region for each camera becomes small, and the screen cannot be clearly watched. For this reason, an abnormal state may be overlooked.

In the technique disclosed in Japanese Laid-open Patent Publication No. H9-98343, since a changed part is overwritten on a frame serving as a base, an image becomes complex to make difficult to visually check an object to be monitored. Furthermore, this technique is a technique which synthesizes time-series images with each other in the same camera and is not a technique which synthesizes video images from a plurality of different cameras with each other.

### SUMMARY

A monitoring support apparatus disclosed in the present application includes image shot information acquiring means which acquires image shot information consisting of continuous frames shot by a plurality of cameras. The apparatus further includes difference region extracting means which compares, in the pieces of acquired image shot information, an arbitrary frame with a previously shot frame or a background frame shot in advance to detect a region including different pixel values and extracts the detected pixel region as a difference region for each of the pieces of image shot information. Furthermore, the apparatus further includes superimposing means which superimposes difference regions for the pieces of image shot information at the same time to generate one frame.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a system configuration diagram of a monitoring system according to a first embodiment;

FIG. 2 is a hardware block diagram of a monitoring support apparatus according to the first embodiment;

FIG. 3 is a functional block diagram of the monitoring support apparatus according to the first embodiment;

FIGS. 4X and 4A to 4H are first diagrams showing video image acquiring information and difference region information of the monitoring support apparatus according to the first embodiment;

FIGS. 5Y and 5A to 5H are second diagrams showing video image acquiring information and difference region information of the monitoring support apparatus according to the first embodiment;

FIG. 6 is a diagram showing superimposed image information of the monitoring support apparatus according to the first embodiment;

FIG. 7 is a flow chart showing an operation of the monitoring support apparatus according to the first embodiment;

FIGS. 8A to 8D are partially enlarged diagrams in a superimposed image generated by the monitoring support apparatus according to the first embodiment;

FIGS. 9A to 9D are partially enlarged diagrams obtained when the superimposed image generated by the monitoring support apparatus according to the first embodiment is associated with security cameras;

FIG. 10 is a diagram showing a process performed when a superimposed image is selected in the monitoring support apparatus according to the first embodiment;

FIG. 11 is a functional block diagram of a monitoring support apparatus according to a second embodiment; and

FIGS. 12A to 12C are diagrams showing an example of frame information generated by the monitoring support apparatus according to the second embodiment.

### DESCRIPTION OF EMBODIMENTS

Embodiments of the present invention will be described below. The present invention is implemented in many different embodiments. Therefore, the present invention should not be interpreted by only the contents described in the present embodiments. The same reference symbols are given to the same elements throughout the present embodiments.

In the following embodiment, an apparatus will be mainly described. However, as is apparent to a person skilled in the art, the present invention can also be implemented as a program to operate a computer. Furthermore, the present invention can be executed as embodiments of hardware, software, or hardware and software. The program can be recorded on an arbitrary computer readable medium such as a hard disk, a CD-ROM, a DVD-ROM, an optical storage device, or a magnetic storage device. The program can also be recorded on another computer connected through a network.

### First Embodiment

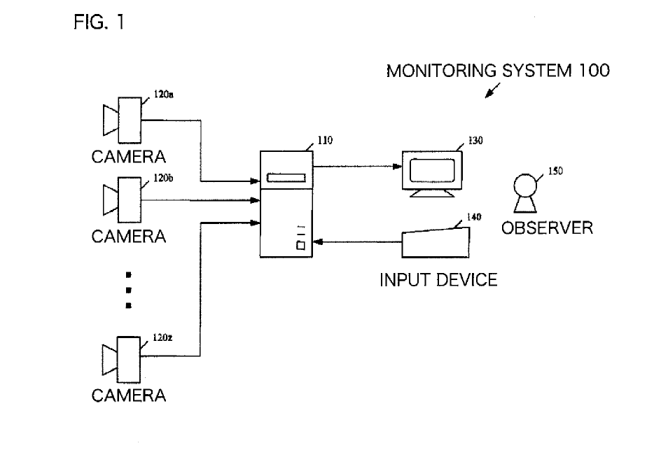

A monitoring support apparatus according to a first embodiment will be described with reference to FIGS. 1 to 10.

FIG. 1 is a system configuration diagram of a monitoring system according to the present embodiment. In FIG. 1, a monitoring system 100 includes a plurality of security cameras 120a to 120z, a monitoring support apparatus 110 which manages the system as a whole, a monitor 130 which displays a monitoring video image, and an input device 140 which performs an input operation to the monitoring support apparatus 110. The system also includes a management server as a dedicated device which manages the system as a whole.

The security camera 120 is installed by being fixed to a point to be monitored to always shoot an image of a region to be monitored. The shot video image is transmitted to the monitoring support apparatus 110 and displayed on the monitor 130.

An observer 150 monitors the video image displayed on the monitor 130 to check whether the video image is abnormal, and inputs instruction information from the input device 140 as needed to perform detailed check of the video image or the like.

The monitoring support apparatus 110 according to the present embodiment edits and displays a video image received from the security camera 120 to prevent monitoring by the observer 150 from being overlooked, and reduces a load on the observer 150 to support the monitoring.

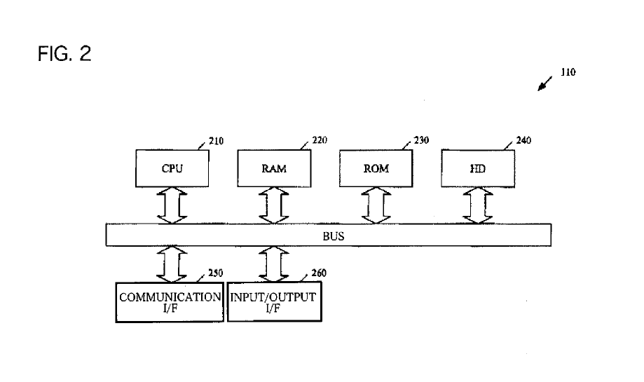

FIG. 2 is a hardware configuration diagram of the monitoring support apparatus 110 according to the present embodiment. The monitoring support apparatus 110 includes a CPU 210, a RAM 220, a ROM 230, a hard disk (referred to as an HD) 240, a communication I/F 250, and an input/output I/F 260. In the ROM 230 or the HD 240, an operating system (referred to as an OS), various programs, and the like are stored and read to the RAM 220 as needed, and the programs are executed by the CPU 210. The communication I/F 250 is an interface to communicate with another device (in this case, the security camera 120). The input/output I/F 260 is an interface which accepts an input from the input device 140 such as a keyboard or a mouse and output data to a printer, the monitor 130, or the like. As the input/output I/F 260, a USB, an RS232C, or the like is used. As needed, a drive corresponding to a removal disk such as a magnetooptical disk, a floppy disk (registered trademark), a CD-R, or a DVD-R can be connected.

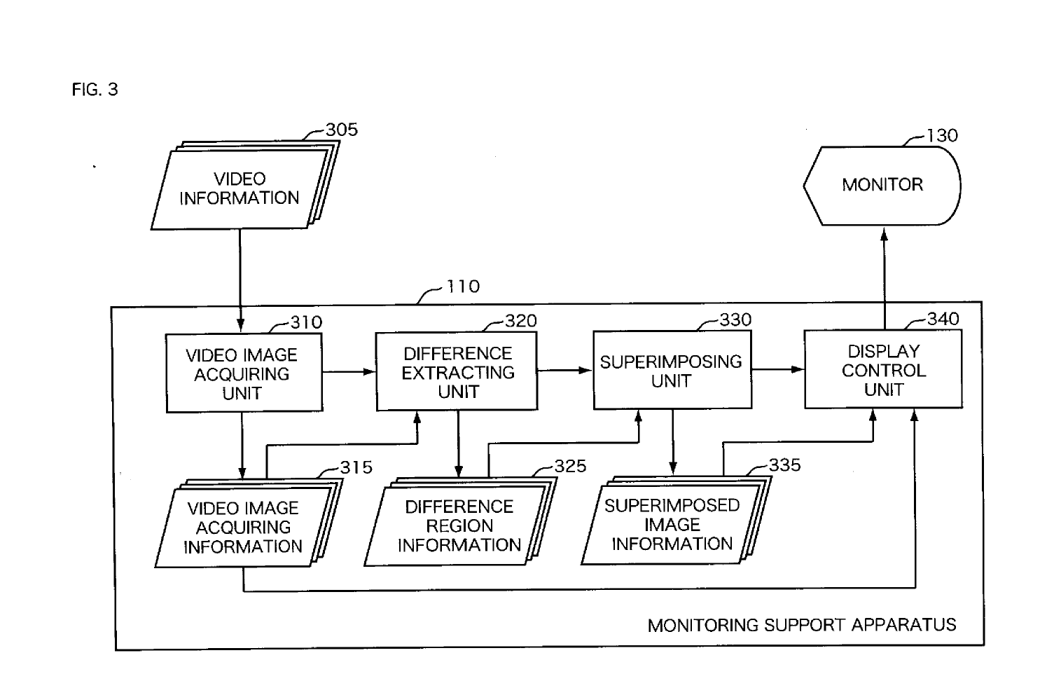

FIG. 3 is a functional block diagram of the monitoring support apparatus 110 according to the present embodiment. The monitoring support apparatus 110 includes a video image acquiring unit 310, a difference extracting unit 320, a superimposing unit 330, and a display control unit 340.

The video image acquiring unit 310 performs a process of acquiring video information 305 shot by the security camera 120. The acquired video information 305 is stored in a database in the monitoring support apparatus 110 as video image acquiring information 315 for each of the security cameras. When the video image acquiring unit 310 acquires the video information, based on the acquired video image acquiring information 315, the difference extracting unit 320 extracts a difference region between an input image and a background image to generate difference region information 325.

As extraction of the difference region, a difference region (hereinafter referred to as a background difference) between an input image and a background image may be extracted, or a difference region (hereinafter referred to as an adjacent difference) between an input image and an image obtained a predetermined period of time before (for example, 1 second before or the like) may be extracted. A difference between moving distances of an input image and an image obtained a predetermined period of time before (for example, 1 second before or the like) may be detected to extract a difference region (hereinafter referred to as an optical flow).

When the difference extracting unit 320 generates the difference region information 325, the superimposing unit 330 superimposes the generated pieces of difference region information 325 of the security cameras to generate superimposed image information 335. When the superimposing unit 330 generates the superimposed image information 335, the display control unit 340 displays the generated superimposed image information 335 on the monitor 130.

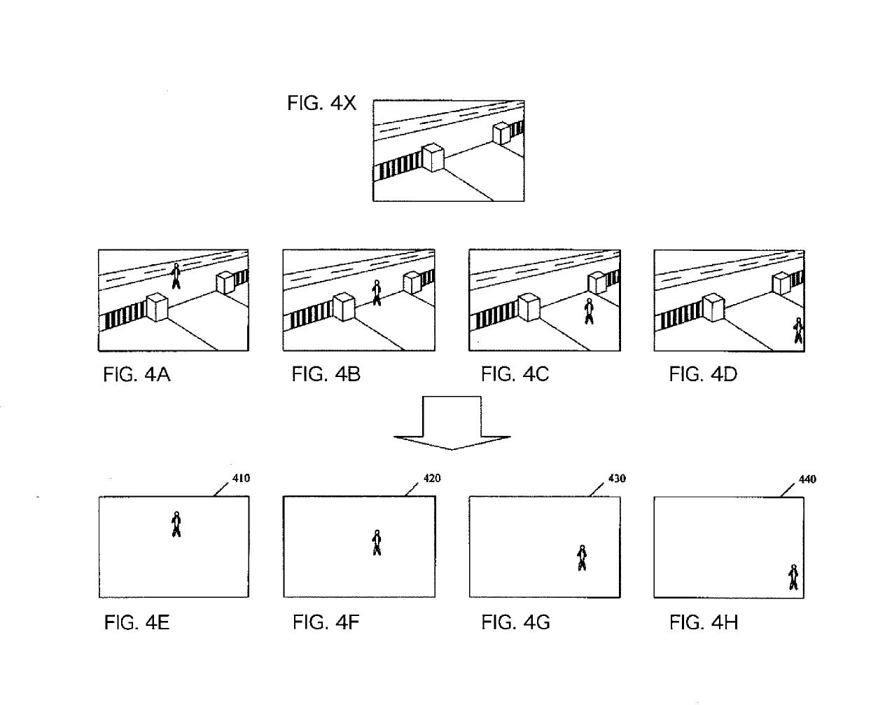

In this case, the video image acquiring information 315, the difference region information 325, and the superimposed image information 335 will be described. FIGS. 4X and 4A to 4H are first diagrams showing an example of video image acquiring information and difference region information of the monitoring support apparatus according to the present embodiment. In this case, it is assumed that the video information 305 shot by a security camera X is acquired by the video image acquiring unit 310. FIG. 4X is a background image shot by the security camera X in advance, and is included in the video image acquiring information 315. FIGS. 4A to 4D show the pieces of video image acquiring information 315 shot by the security camera X. FIGS. 4A to 4D show the video image acquiring information 315 in a chronological order (for example, every second). As is apparent from the figures, an image of a scene in which a person enters from a gate is shot.

In FIGS. 4E to 4H, the images in FIGS. 4A to 4D are compared with the background image in FIG. 4X, and different pixel regions are extracted. In FIGS. 4A to 4D, the background does not change, and only the person moves. For this reason, only a pixel region of the person is extracted as a difference region, and the pieces of difference region information 325 (difference images 410 to 440) are generated.

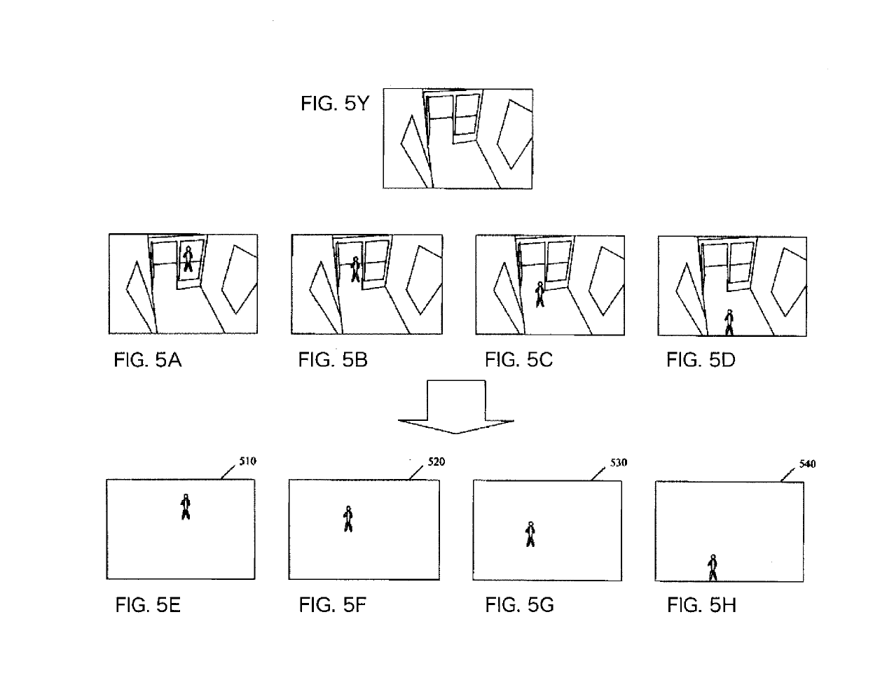

FIGS. 5Y and 5A to 5H are second diagrams showing an example of video image acquiring information and difference region information of the monitoring support apparatus according to the present embodiment. In FIGS. 5Y and 5A to 5H, as in the case in FIG. 4X and FIGS. 4E and 4H, based on the video information 305 of the security camera Y installed at another position, different pixel regions are extracted by the video image acquiring information 315 (FIGS. 5A to 5D) and the background image (FIG. 5Y). Also in this case, in FIGS. 5A to 5D, the background does not change, and only the person moves. For this reason, only a pixel region of the person is extracted as a difference region, and the pieces of difference region information 325 (FIGS. 5E to 5H, i.e., difference images 510 to 540) are generated.

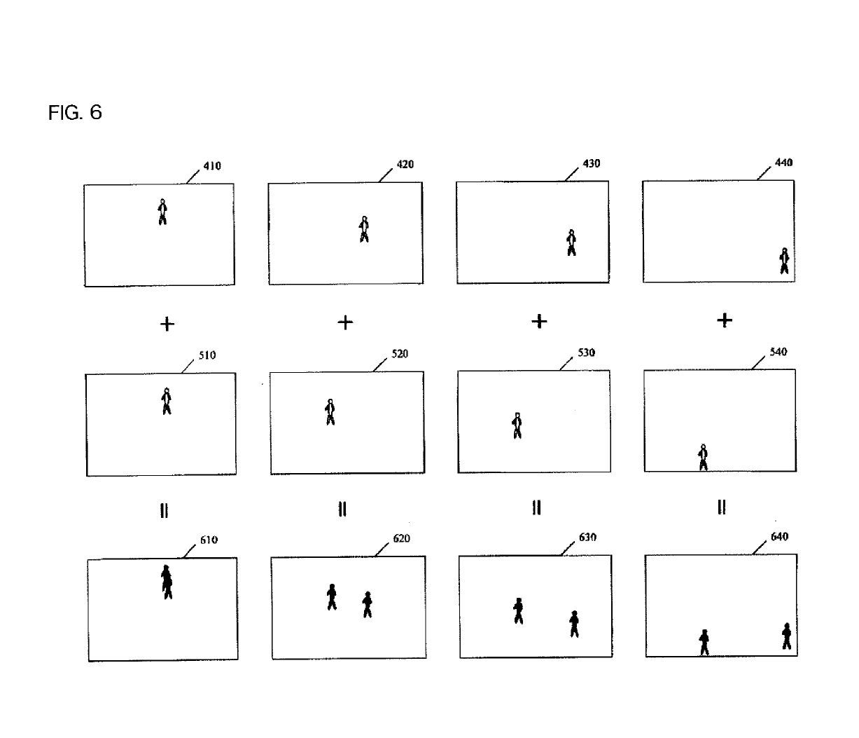

FIG. 6 is a diagram showing an example of superimposed image information of the monitoring support apparatus according to the present embodiment. In FIG. 6, the pieces of difference region information 325 (the difference images 410 to 440) generated based on the pieces of video information shot by the security camera X are superimposed on the pieces of difference region information 325 (the difference images 510 to 540) generated based on pieces of video information shot by a security camera Y, respectively. When the images are superimposed, the pieces of superimposed image information 335 (superimposed images 610 to 640) are generated. More specifically, the difference image 410 and the difference image 510 are superimposed to generate the superimposed image 610. The difference image 420 and the difference image 520 are superimposed to generate the superimposed image 620. The difference image 430 and the difference image 530 are superimposed to generate the superimposed image 630. The difference image 440 and the difference image 540 are superimposed to generate the superimposed image 640.

The superimposed image information 335 may be generated with an emphasized contrast to make a difference region clear.

Background images may be selectively used in units of weathers, seasons, and time zones. More specifically, in a time zone in which it is bright such as a fine weather, summertime, or daytime and a time zone in which it is dark such as a rainy day, wintertime, or night, different pixel regions may influence backgrounds. When the background images are selectively used, these problems can be prevented.

The background image may be formed not only in advance but also dynamically. More specifically, the background image does not include a change in status. However, when the change in status is small or when time is short, images are acquired from a video image at predetermined intervals (for example, every minute) and averaged, and a background image can also be dynamically formed.

The superimposed image information 335 generated in FIG. 6 is displayed on the monitor 130 by the display control unit 340. The observer 150 monitors the displayed screen to reliably detect abnormality.

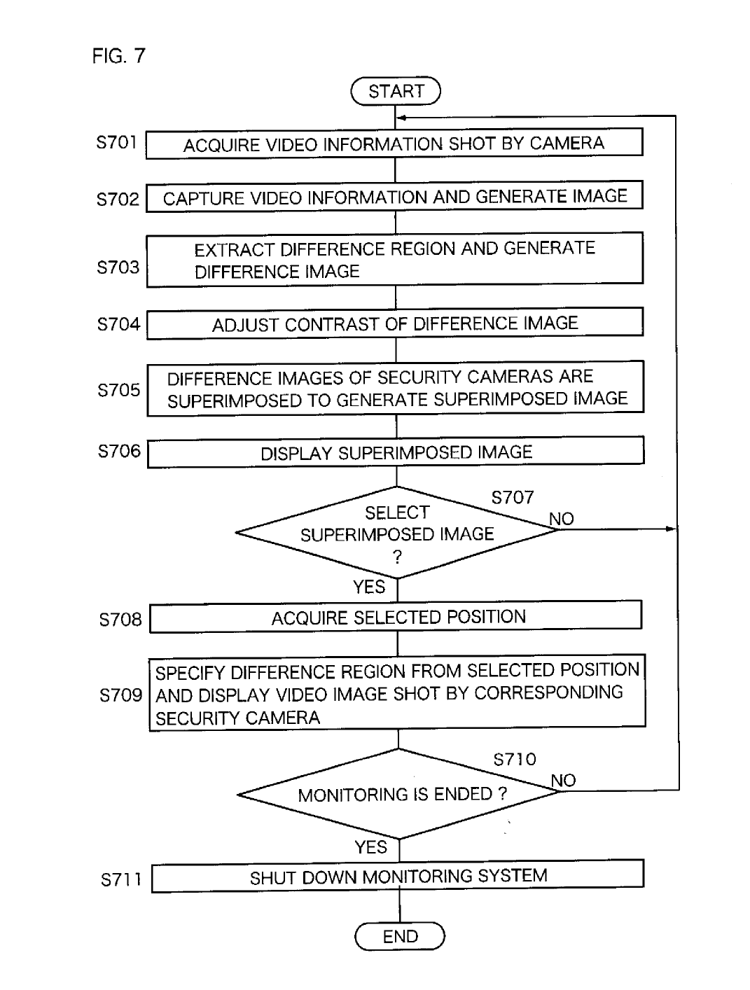

FIG. 7 is a flow chart showing an operation of the monitoring support apparatus according to the present embodiment. First, the video image acquiring unit 310 acquires the video information 305 shot by the security camera 120 (step S701). The acquired video information 305 is captured to generate image information (step S702). The difference region information 325 extracts a difference region between the captured image information and a background image shot in advance to generate a difference image (step S703).

Whether or not a difference region is present is determined. When it is determined that the difference image is not present, the process may return to the process in step S701 without generating a difference image. The determination for the presence/absence of a difference region may be performed based on the number of pixels which change. More specifically, when the number of pixels which change is equal to or smaller than a reference value set in advance, it is determined that a difference region is not present.

The extraction of the difference region will be described. As described above, the difference region can be extracted by a background difference, an adjacent difference, or an optical flow. In the present embodiment, a difference region is extracted by the background difference (see FIGS. 4X and 4A to 4H and FIGS. 5Y and 5A to 5H).

As methods of expressing the extracted difference region, (1) a method of setting a region which changes with respect to the background image as a difference region, (2) a method of setting a region which changes with respect to a previous image as a difference region, (3) a method of setting only a contour of a region which changes as a difference region, and the like are given.

For example, in the method (1), the change is for the background image. For this reason, when it is determined that one person moves, a present state of the person is extracted as a difference region. In the method (2), the change is for the previous image. When an image of a person is shot as a previous image (for example, an image obtained one second before), a present state of the person and a state one second before are extracted as a difference region. In the method (3), only a contour in a region is extracted as a difference region. The case in which only the contour is extracted as the difference region will be described below in detail.

In any methods, it is assumed that a portion which is not extracted as a difference region is extracted as a monochromatic region (for example, black).

When the difference image is generated in step S703, in order to emphasize the difference image, a contrast of the difference image is adjusted (step S704). Difference images generated by the security cameras are superimposed to generate a superimposed image (step S705).

The superimposed image will be described below. The different images of the security cameras are superimposed, so that motion of the plurality of security cameras can be monitored by one superimposed image. However, if the difference images are simply superimposed, a visual check may be difficult when difference regions overlap. Therefore, in the present embodiment, only the contours of the difference regions are superimposed, semi-transparently superimposed, and/or superimposed by using different colors for each of the security cameras.

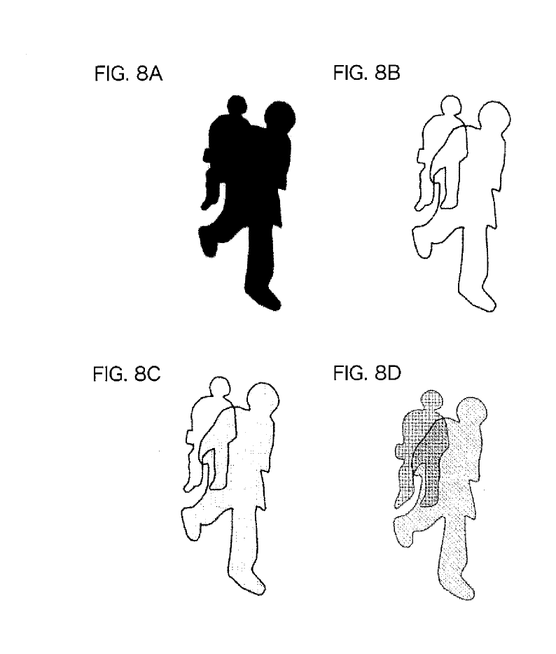

FIGS. 8A to 8D are partially enlarged diagrams in a superimposed image generated by the monitoring support apparatus according to the present embodiment. FIG. 8A shows an example of a superimposed image obtained when different regions are simply superimposed. In this state, it can be somehow visually recognized that there are two persons. However, it is difficult to perform monitoring so that the two persons are clearly distinguished. Moreover, a smaller difference region (third person) may be hidden and may not be visually recognized.

Under the condition in FIG. 8A, FIG. 8B is a superimposed image obtained when only a contour is extracted as a difference region. In FIG. 8, since only contours of two persons are extracted, the persons can be clearly distinguished, and the visibility is improved in comparison with FIG. 8A. Furthermore, the presence/absence of another person can be visually recognized.

Under the condition in FIG. 8A, FIG. 8C is a superimposed image obtained when one person is made semi-transparent. In this manner, the difference region is made semi-transparent to make it possible to clearly distinguish the two persons as in the case in FIG. 8B and to improve the visibility.

Under the condition in FIG. 8A, FIG. 8D is a superimposed image obtained when the images of the persons are distinguished by using different colors for each of the security cameras. In this case, for illustrative convenience, color differences are expressed as differences of marked patterns. That is, actually, for example, a check pattern is in red, and a shaded pattern is in blue. An overlapping region is in a color obtained by adding color tones or the like (in this figure, addition of a check pattern and a shaded pattern). In this manner, difference regions are distinguished by using different colors for each of the security cameras to make it possible to clearly distinguish two persons as in the cases in FIGS. 8B and 8C and to improve the visibility.

Since a single color (for example, black) is superimposed on a portion which is not extracted as a difference region, a superimposed image is also in a single color.

It is assumed that a method of superimposing only a contour of a difference region, a semi-transparently superimposing method, and a superimposing method using different colors for each of the security cameras are arbitrarily combined. For example, as to the colors of the contours in FIG. 8B, different colors may be used for each of the security cameras. One person in FIG. 8D may be made semi-transparent.

Returning to FIG. 7, when a superimposed image is generated in step S705, the display control unit 340 displays the generated superimposed image on the monitor 130 (step S706).

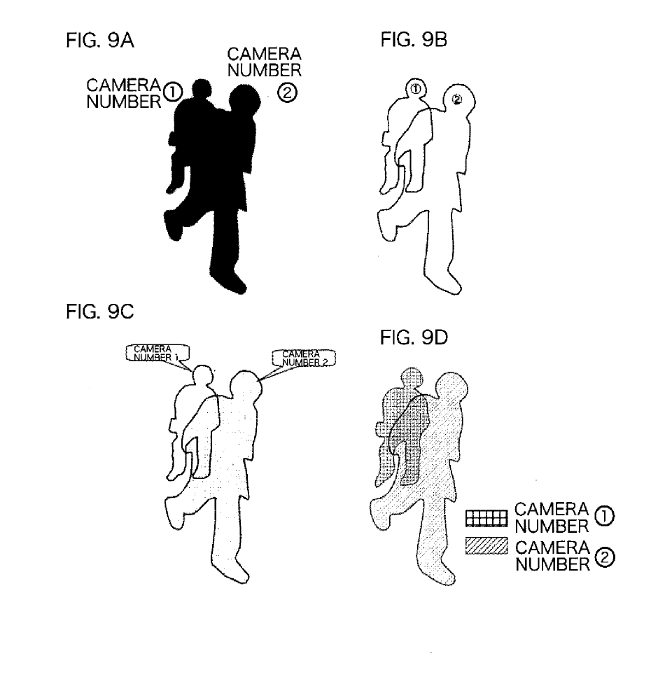

In this case, a display mode of a superimposed image will be described. Since the superimposed image includes difference regions of the plurality of security cameras, the security cameras and the difference regions are associated with each other. FIGS. 9A to 9D are partially enlarged diagrams when superimposed images generated by the monitoring support apparatus according to the present embodiment are associated with the security cameras. In FIGS. 9A to 9C, pieces of identification information (camera numbers) of the security cameras are associated with the difference regions, respectively, and are closely displayed. At this time, when only the contour is extracted as a difference region as shown in FIG. 9B, the camera number can also be displayed inside the region. In FIG. 9D, although the pieces of information are not closely displayed in the difference region, association information which associates the camera numbers and the colors with each other is displayed in the same screen. For this reason, the difference regions and the security cameras can be associated with each other.

It is assumed that a display mode of a difference region and a display mode of the identification information of the security camera can be arbitrarily combined to each other.

Returning to FIG. 7, when a superimposed image is displayed in step S706, it is determined whether the observer 150 selects (clicks) the superimposed image by using the input device 140 such as a mouse (step S707). When the observer 150 does not select the superimposed image, the process returns to step S701, and a new video image of a security camera is acquired. When the superimposed image is selected, the selected position is acquired (step S708), a difference region is specified from the acquired position, and a video image of a corresponding security camera is displayed (step S709).

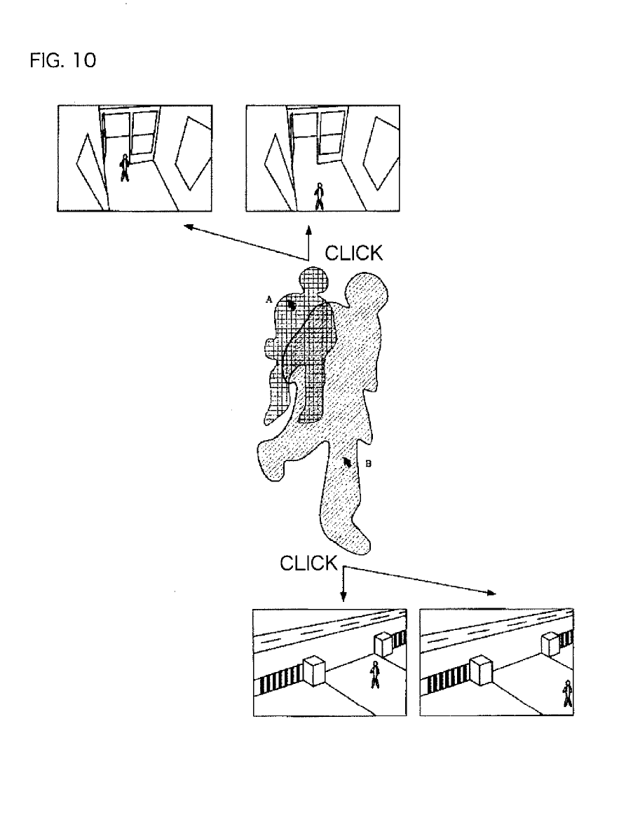

A process performed when the superimposed image is clicked will be described. FIG. 10 is a diagram showing the process performed when the superimposed image is selected in the monitoring support apparatus according to the present embodiment. In FIG. 10, arrows A and B indicate mouse pointers, respectively. A person selected by the arrow A is a person shot by the security camera Y (see FIGS. 5Y and 5A to 5H), and a person selected by an arrow B is a person shot by the security camera X (see FIG. 4).

When the mouse pointer of the arrow A is clicked, a present video image of the security camera Y corresponding to a selected difference region is displayed. When the mouse point of the arrow B is clicked, a present video image of the security camera X corresponding to a selected difference region is displayed.

The video image of the security camera X or Y may be displayed on the same screen as that of the superimposed image or may be displayed on another screen.

Even though selection is not performed by the mouse or the like, a video image of a security camera determined to be changed based on an extracted difference region may be specified and displayed into divided regions.

Returning to FIG. 7, it is determined whether monitoring is ended (step S710). When the monitoring is continued, the process returns to step S701, and a new video image of a security camera is acquired. When the monitoring is to be ended, the monitoring system is shut down (step S711), and the process is ended.

According to the monitoring support apparatus according to the present embodiment, one frame is generated by superimposing difference images shot by a plurality of cameras. For this reason, an observer only need to monitor one screen to check video images of all the cameras, thereby reducing a load on the observer.

When the plurality of video images are superimposed without being divided vertically and horizontally, video display regions are prevented from being reduced and an abnormality is prevented from being overlooked.

Since only the difference regions are superimposed without superimposing all the video images, an object to be monitored can be easily checked, an abnormality can be prevented from being overlooked, and a load on the observer can be reduced.

Furthermore, since only the contours of the difference regions are extracted, even if a plurality of difference regions overlap at the same position when the difference regions are superimposed, the difference regions can be monitored so that the difference regions are clearly distinguished.

Since the difference regions are made semi-transparent and/or superimposed by using different colors for corresponding cameras, the difference regions can be monitored such that the difference regions are clearly distinguished.

Further, a frame generated by superimposing the difference images is displayed, and video images of corresponding cameras are displayed in units of selected pieces of difference information. For this reason, when an abnormality is detected in the difference information, a video image of a camera can be immediately checked.

Since the pieces of identification information of corresponding cameras are displayed to close up difference regions, the difference regions and the cameras can be easily associated with each other. An observer can be advantageously check monitoring states of a plurality of positions without a load on the observer.

### Second Embodiment

In the first embodiment, a superimposed image obtained by superimposing a plurality of difference regions is displayed on the same screen. However, a difference region obtained from images shot by a certain camera is displayed in a predetermined region on a screen, and a configuration (multi-display) which displays a difference region obtained from images shot up by another camera in another region of the same screen may be used.

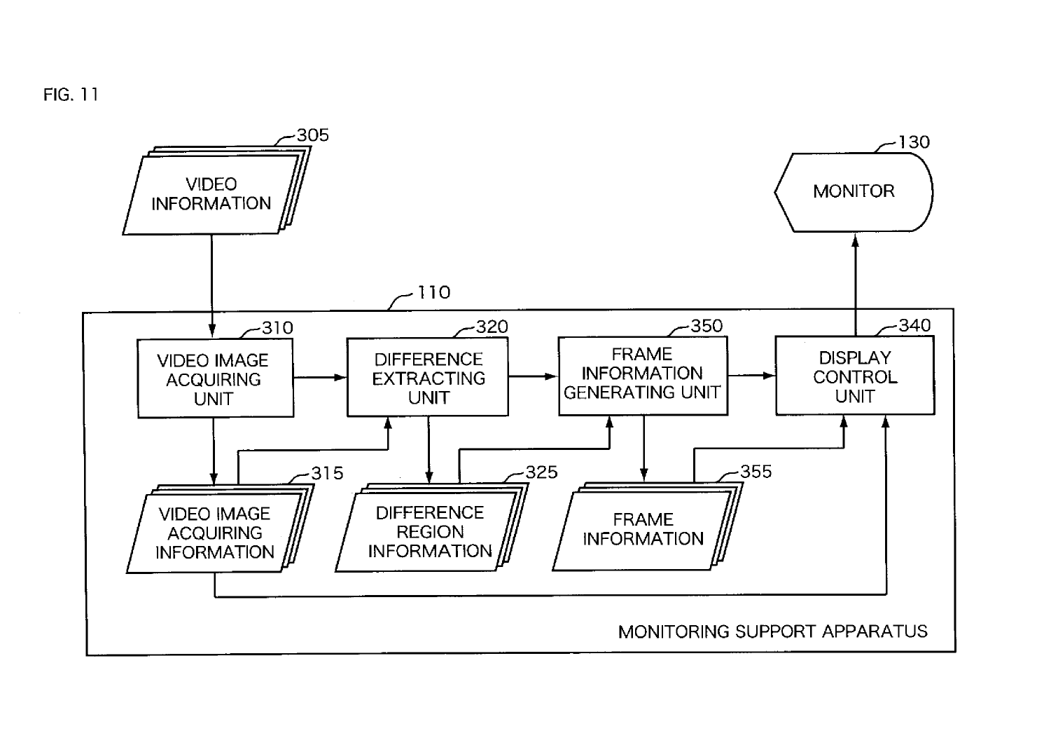

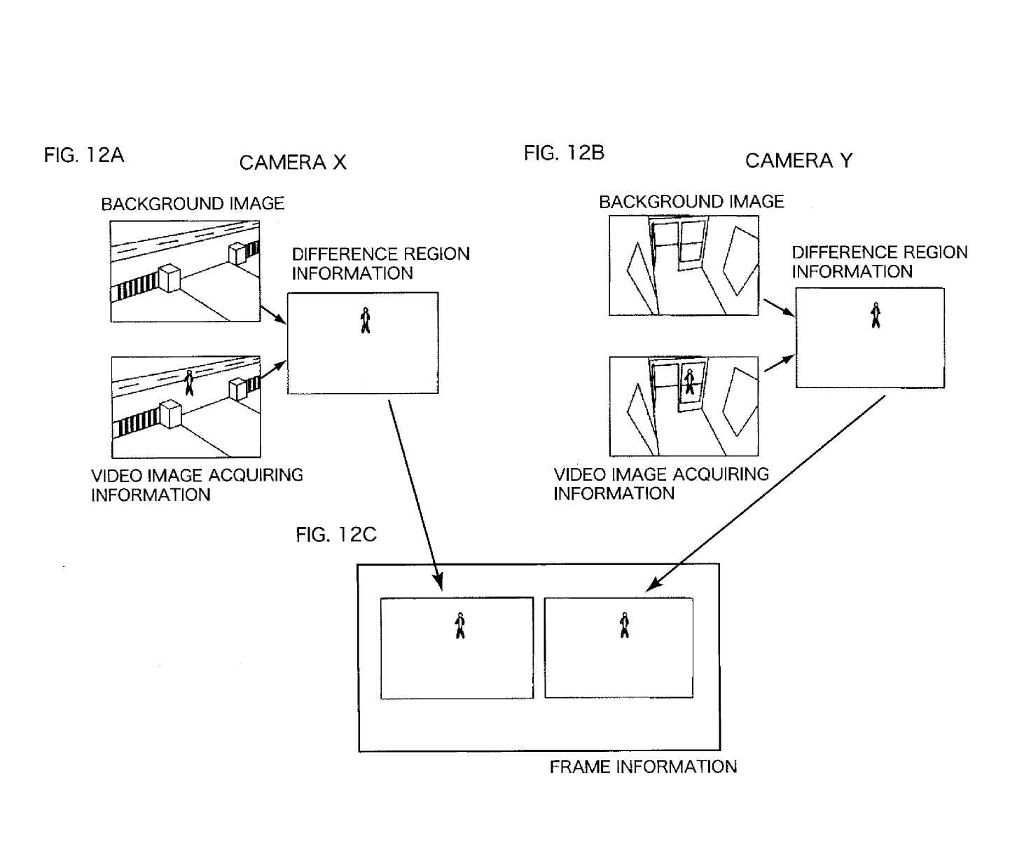

A monitoring support apparatus according to a second embodiment will be described with reference to FIGS. 11 and 12. A hardware configuration of the monitoring support apparatus is exactly the same as that in the first embodiment.

FIG. 11 is a functional block diagram of the monitoring support apparatus 110 according to the second embodiment. The monitoring support apparatus 110 includes the video image acquiring unit 310, the difference extracting unit 320, a frame information generating unit 350, and the display control unit 340.

The video image acquiring unit 310 performs a process of acquiring the video information 305 shot by the security camera 120. The acquired pieces of video information 305 are stored as pieces of video image acquiring information 315 in a database in the monitoring support apparatus 110 in units of security cameras. When the video image acquiring unit 310 acquires video image, based on the acquired video image acquiring information 315, the difference extracting unit 320 extracts a difference region between an input image and the background image to generate the difference region information 325.

As to extraction of a difference region, a difference region between an input image and a background image may be extracted, or a difference region between an input image and an image obtained a predetermined period of time before (for example, 1 second before or the like) may be extracted. A difference between moving distances of an input image and an image obtained a predetermined period of time before (for example, 1 second before or the like) may be detected to extract a difference region.

When the difference extracting unit 320 generates the difference region information 325, the frame information generating unit 350 generates frame information to display the pieces of difference region information 325 in units of security cameras in predetermined regions on screens. When the frame information generating unit 350 generates frame information 355, the display control unit 340 displays the generated frame information 355 on the monitor 130.

FIGS. 12A to 12C are diagrams showing an example of frame information generated by the monitoring support apparatus 110 according to the second embodiment. The monitoring support apparatus 110, for example, as shown in FIG. 12A, based on a background image shot by the security camera X in advance and pieces of video image acquiring information obtained every second, difference region information is generated. The monitoring support apparatus 110, as shown in FIG. 12B, based on a background image shot by the security camera Y in advance and pieces of video image acquiring information obtained every second, difference region information is generated.

FIGS. 12A and 12B shows manners in which difference region information is generated based on images shot by the security camera X and the security camera Y at certain time.

The monitoring support apparatus 110 generates frame information in which difference region information generated based on images shot by the security camera X is arranged in a predetermined region (left region of the screen in the example in FIG. 12C) and difference region information generated based on images shot by the security camera Y is arranged in another region (right region of the screen in the example in FIG. 12C). The monitoring support apparatus 110, based on the frame information as shown in FIG. 12C, displays an image on the monitor 130 to perform multi-display of the difference region information.

In this manner, according to the monitoring support apparatus according to the second embodiment, a single frame is generated from difference images shot by a plurality of cameras. For this reason, an observer only need to monitor one screen to check video images of all the cameras, thereby reducing a load on the observer.

In the present embodiment, one piece of difference region information is arranged in the left region of the screen, and the other piece of difference region information is arranged in the right region of the screen. However, the arrangement of the pieces of difference region information is not limited to a horizontal arrangement. In the present embodiment, pieces of video information are acquired from three or more security cameras, pieces of difference region information is generated from the pieces of video information, and multi-display in which the pieces of difference region information are arranged on the same screen may be performed as a matter of course.

When a difference region is not extracted in the difference extracting unit 320, i.e., when video image obtained from a security camera is the same as a background image, a predetermined region on a corresponding screen is blacked out, or it is displayed on the predetermined region that the video information does not change.

The embodiments described above, as is apparent to a so-called person skilled in the art, can be captured as a method and a program. As another embodiment, a configuration obtained by applying the constituent elements of the monitoring support apparatus disclosed in the present application or an arbitrary combination of the constituent elements to a method, an apparatus, a circuit, a system, a computer program, a recording medium, a data structure, or the like is effective.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification related to a showing of the superiority and inferiority of the invention. Although the embodiments of the present inventions have been described in detail, it should be understood that the various changes, substitutions, and alternations could be made hereto without departing from the spirit and scope of the invention.

What is claimed is:

1. A monitoring support apparatus, comprising:
an image shot information acquiring unit which acquires image shot information including a plurality of frames shot by a plurality of cameras at different image shooting times;
a difference region extracting unit which, in the pieces of image shot information acquired by the image shot information acquiring unit, compares an arbitrary frame with a frame shot at image shooting time different from image shooting time of the arbitrary frame or a background frame shot in advance to detect a region including different pixel values and extracts the detected pixel region as a difference region for each of the pieces of image shot information; and
a superimposing unit which superimposes the difference regions of the pieces of image shot information extracted by the difference region extracting unit at the same time to generate one frame.

2. The monitoring support apparatus according to claim 1, wherein the difference region extracting unit extracts only a contour of the difference region.

3. The monitoring support apparatus according to claim 1, wherein the image shot information acquiring unit acquires the pieces of image shot information in units of the cameras, and the superimposing unit superimposes images generated by performing different image processing for the corresponding cameras to generate one frame.

4. The monitoring support apparatus according to claim 1, further comprising a display unit which displays the frame generated by the superimposing unit; wherein
when one arbitrary difference region displayed by the display unit is selected, image shot information acquired by the image shot information acquiring unit corresponding to the selected arbitrary difference region is displayed.

5. The monitoring support apparatus according to claim 1, further comprising the display unit which displays the frame generated by the superimposing unit; wherein
the display unit displays identification information which identifies a camera which shoots a difference region on the displayed frame to close up the corresponding difference region.

6. A monitoring support apparatus comprising:
an image shot information acquiring unit which acquires image shot information including a plurality of frames shot by a plurality of cameras at different image shooting times;
a difference region extracting unit which compares, in the pieces of image shot information acquired by the image shot information acquiring unit, an arbitrary frame with a frame shot at image shooting time different from image shooting time of the arbitrary frame or a background frame shot in advance to detect a region including different pixel values and extracts the detected pixel region as a difference region for each of the pieces of image shot information; and
a frame generating unit which generates a frame which displays difference regions of the pieces of image shot information extracted by the difference region extracting unit at the same time.

7. A monitoring support method comprising the steps of:
acquiring by a computer image shot information including a plurality of frames shot by a plurality of cameras at different image shooting times;
in the acquired pieces of image shot information, comparing an arbitrary frame with a frame shot up at image shooting time different from image shooting time of the arbitrary frame or a background frame shot in advance to cause the computer to detect a region including different pixel values;
extracting the detected pixel region as a difference region for each of the pieces of image shot information by the computer; and
superimposing the extracted difference regions of the pieces of image shot information at the same time to generate one frame.

8. The monitoring support method according to claim 7, wherein, upon extraction of the difference region, only a contour of the difference region is extracted.

9. The monitoring support method according to claim 7, wherein,
the pieces of image shot information are acquired in units of the cameras; and
upon superimposing the difference regions, images generated by performing different image processing are superimposed for the corresponding cameras to generate one frame.

10. The monitoring support method according to claim 7, further comprising the steps of displaying the generated frame on a display unit, wherein
when one arbitrary difference region displayed by the display unit is selected, image shot information acquired by the image shot information acquiring unit corresponding to the selected arbitrary difference region is displayed.

11. The monitoring support method according to claim 7, further comprising the step of displaying the generated frame on a display unit; wherein
the display unit displays identification information which identifies a camera which shoots up a difference region on the displayed frame to close up the corresponding difference region.

12. A computer readable recording medium on which a computer program for monitoring support is recorded, the computer program comprising the steps of:
causing the computer to, based on pieces of image shot information including a plurality of frames shot up by a plurality of cameras at different image shooting times, in the pieces of image shot information, compare an arbitrary frame with a frame shot up at image shooting time different from image shooting time of the arbitrary frame or a background frame shot in advance to detect a region including different pixel values;
causing the computer to extract the detected pixel region as a difference region for each of the pieces of image shot information; and
causing the computer to superimpose the extracted difference regions of the pieces of image shot information at the same time to generate one frame.

13. The recording medium according to claim 12, wherein the computer program causes the computer, upon extraction of the difference, to extract only a contour of the difference region.

14. The recording medium according to claim 12, wherein
the computer program
causes the computer to acquire the pieces of image shot information in units of the cameras; and
upon superimposing the difference regions, causes the computer to superimpose images generated by performing different image processing for the corresponding cameras to generate one frame.

15. The recording medium according to claim 12, wherein
the computer program
causes the computer to display the generated frame; and
causes the computer to, when the displayed arbitrary difference region is selected, display image shot information corresponding to the selected arbitrary difference region.

16. The recording medium according to claim 12, wherein
the computer program
causes the computer to display the generated frame; and
causes the computer to display identification information which identifies a camera which shoots up a difference region on the displayed frame to close up the corresponding difference region.
